(19) United States
(12) Patent Application Publication
(10) Pub. No.: US 2004/0164232 A1
(43) Pub. Date: Aug. 26, 2004

(54) Photocurrent-to-binary signal conversion apparatus capable of suppressing waveform distortion

(75) Inventor: Kurao Nakagawa, Shiga (JP)

Correspondence Address: SUGHRUE MION, PLLC, 2100 PENNSYLVANIA AVENUE, N.W., SUITE 800, WASHINGTON, DC, 20037, US

(73) Assignee: NEC COMPOUND SEMICONDUCTOR DEVICES, LTD.

(21) Appl. No.: 10/782,959

(22) Filed: Feb. 23, 2004

(30) Foreign Application Priority Data
Feb. 24, 2003 (JP) 2003-045274

(51) Int. Cl. H01J 40/14

(52) U.S. Cl. 250/214 R; 250/214 A

(57) ABSTRACT

In a photocurrent-to-binary signal conversion apparatus, a light receiving element receives a light signal so that a photocurrent in response to the light signal flows through the light receiving element. An amplifier converts the photocurrent into a detection voltage. A reference voltage generating circuit offsets the detection voltage on the side of the detection voltage to generate a reference voltage. A comparator compares the detection voltage with the reference voltage to generate a binary signal in accordance with whether or not the detection voltage is higher than the reference voltage.

### BACKGROUND OF THE INVENTION

1. Field of the Invention

The present invention relates to a photocurrent-to-binary signal conversion apparatus capable of suppressing waveform distortion.

2. Description of the Related Art

Generally, in order to electrically insulate an input from an output in factory automation (FA) or the like, a photocoupler has been developed. In such a photocoupler, a photocurrent-to-binary conversion apparatus is used. Also, a photocurrent-to-binary signal conversion apparatus is used in a light receiving circuit in infrared communication or optical cable communication. Further, a photocurrent-to-binary signal conversion apparatus is used in a light detection circuit for converting a laser reflection signal into an electrical digital signal of an optical disc unit.

A prior art photocurrent-to-binary signal conversion apparatus is constructed by a light receiving element for receiving a light signal so that a photocurrent in response to the light signal flows therethrough, an amplifier for converting the photocurrent into a detection voltage, a reference voltage generating circuit for offsetting an input voltage of the amplifier on the side of this input voltage to generate a reference voltage, a time constant circuit including voltage dividing resistors and a capacitor between the output of the amplifier and the output of the reference voltage generating circuit to generate a threshold voltage, and a comparator for comparing the detection voltage with the threshold voltage to generate a binary signal (see: U.S. Pat. No. 5,061,859). This will be explained later in detail.

In the above-described prior art photocurrent-to-binary signal conversion apparatus, however, waveform distortion between a photocurrent and a binary signal and waveform distortion between different binary signals corresponding to different levels of photocurrents are generated.

### SUMMARY OF THE INVENTION

It is an object of the present invention to provide a photocurrent-to-binary signal conversion apparatus capable of suppressing the waveform distortion.

According to the present invention, in a photocurrent-to-binary signal conversion apparatus, a light receiving element receives a light signal so that a photocurrent in response to the light signal flows through the light receiving element. An amplifier converts the photocurrent into a detection voltage. A reference voltage generating circuit offsets the detection voltage on the side of the detection voltage to generate a reference voltage. A comparator compares the detection voltage with the reference voltage to generate a binary signal in according with whether or not the detection voltage is higher than the reference voltage.

### BRIEF DESCRIPTION OF THE DRAWINGS

The present invention will be more clearly understood from the description set forth below, as compared with the prior art, with reference to the accompanying drawings, wherein:

FIG. 1 is a circuit diagram illustrating a prior art photocurrent-to-binary signal conversion apparatus;

FIGS. 2A, 2B, 2C, 2D, 3A, 3B, 4A and 4B are timing diagrams for explaining the operation of the photocurrent-to-binary signal conversion apparatus of FIG. 1;

FIG. 5 is a circuit diagram illustrating a first embodiment of the photocurrent-to-binary signal conversion apparatus according to the present invention;

FIGS. 6A, 6B, 6C, 7A, 7B, 8A and 8B are timing diagrams for explaining the operation of the photocurrent-to-binary signal conversion apparatus of FIG. 5; and

FIG. 9 is a circuit diagram illustrating a second embodiment of the photocurrent-to-binary signal conversion apparatus according to the present invention;

FIGS. 10A and 10B are detailed circuit diagrams of the amplifier of FIG. 9; and

FIG. 11 is a circuit diagram illustrating a third embodiment of the photocurrent-to-binary signal conversion apparatus according to the present invention.

### DESCRIPTION OF THE PREFERRED EMBODIMENTS

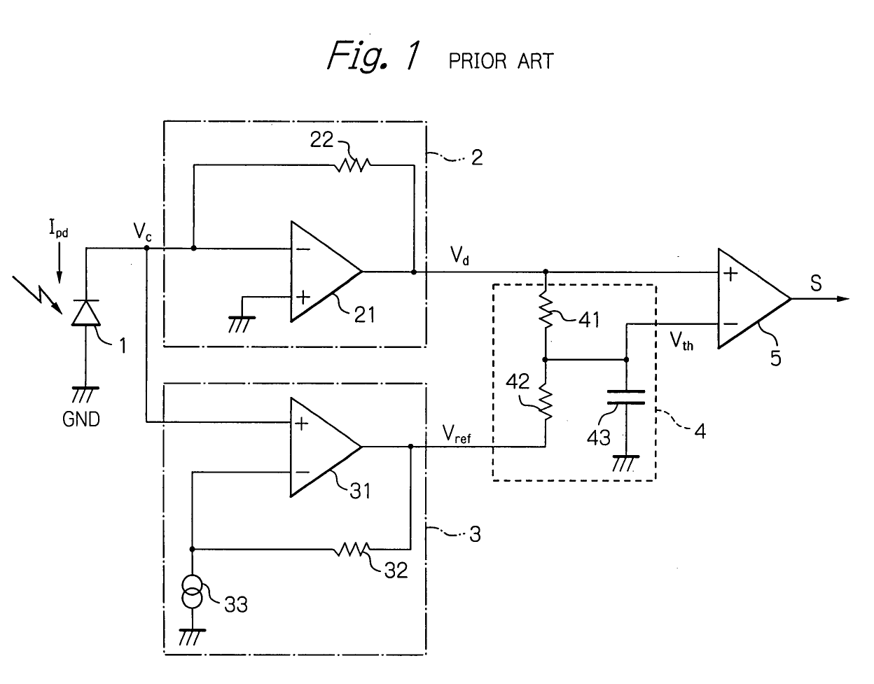

Before the description of the preferred embodiments, a prior art photocurrent-to-binary signal conversion apparatus will be explained with reference to FIGS. 1, 2A, 2B, 2C, 2D, 3A, 3B, 4A and 4B.

In FIG. 1, which illustrates a prior art photocurrent-to-binary signal conversion apparatus (see: U.S. Pat. No. 5,061,859), reference numeral 1 designates a photodiode having a grounded anode and a cathode. When the photodiode 1 receives a light signal, a photocurrent I_{pd} flows from the cathode to the anode.

An amplifier 2 is connected to the cathode of the photodiode 1. The amplifier 2 converts the photocurrent I_{pd} into a detection voltage V_{d}. The amplifier 2 is constructed by an operational amplifier 21 having a grounded non-inverting input and an inverting input connected to the photodiode 1, and a negative feedback resistor 22 connected between the output and inverting input of the operational amplifier 21.

A reference voltage generating circuit 3 is connected to the cathode of the photodiode 1. That is, the reference voltage generating circuit 3 offsets a voltage V_{c} at the cathode of the photodiode 1 on the side of the voltage V_{c} to generate a reference voltage V_{ref}. The reference voltage generating circuit 3 is constructed by an operational amplifier 31 having a non-inverting input connected to the cathode of the photodiode 1, a negative feedback resistor 32 connected between the output and inverting input of the operational amplifier 31, and a constant current source 33 having an end connected to the inverting input of the operational amplifier 31 and the negative feedback resistor 32 and a grounded end.

A time constant circuit 4 divides a difference between the detection voltage V_{d} of the amplifier 2 and the reference voltage V_{ref} to generate a threshold voltage Vₜₕ. The time constant circuit 4 is constructed by voltage dividing resistors 41 and 42 connected in series between the output of the amplifier 2 and the output of the reference voltage generating circuit 3, and a capacitor 43 connected to a node between the voltage dividing resistors 41 and 42. For example, the voltage dividing ratio by the voltage dividing resistors 41 and 42 is 1:2.

A comparator 5 compares the detection voltage V_{d} of the amplifier 2 with the threshold voltage Vₜₕ of the time constant circuit 4 to generate a binary signal S in accordance with whether or not the detection signal V_{d} is higher than the threshold voltage Vₜₕ.

In FIG. 1, when no light signal is incident to the photodiode 1, no photocurrent I_{pd} flows therethrough. As a result, in the amplifier 2, since no current flows through the negative feedback resistor 22, the detection voltage V_{d} is the same as the voltage VC at the cathode of the photodiode 1. In this case,

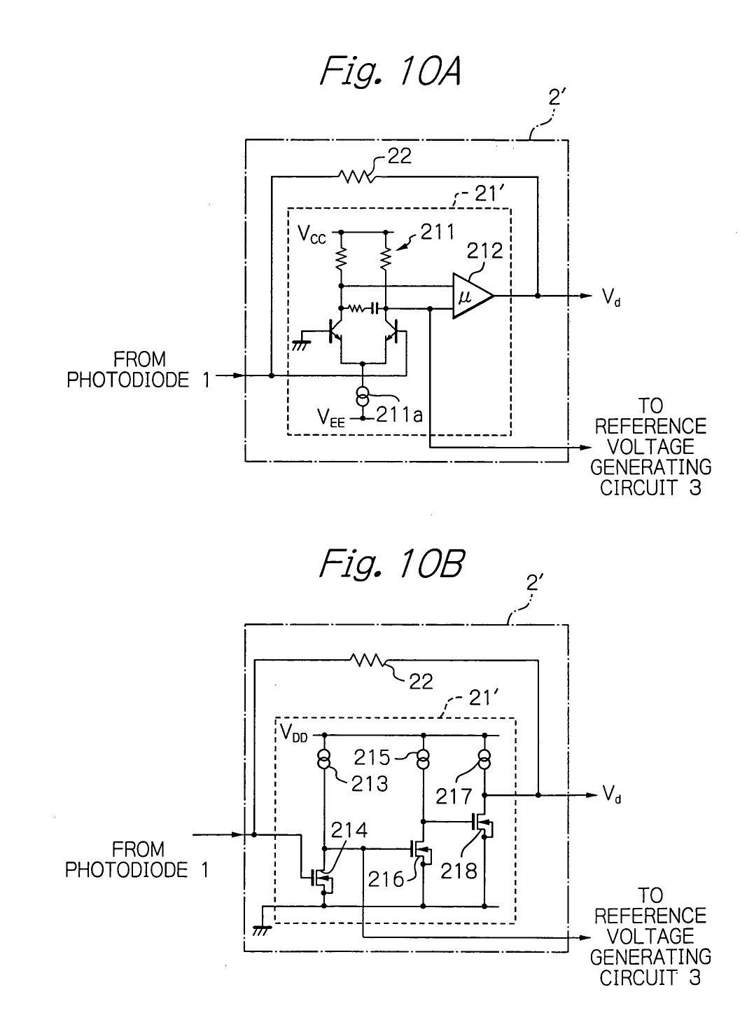

V_{d}=V_{c}=Vₒₛ₁

where Vₒₛ₁ is an offset voltage of the operational amplifier 21 depending the current of a constant current source (see: 211a of FIG. 10A) therein. Also, in the reference voltage generating circuit 3, since the negative feedback resistor 32 and the constant current source 33 generate an offset voltage Vₒₛ₂, the offset voltage Vₒₛ₂ is applied to the voltage V_{c} at the photodiode 1, so that the reference voltage V_{ref} is given by

V_{ref}=Vₒₛ₁+Vₒₛ₂

As a result, in the time constant circuit 4, the threshold voltage Vₜₕ is given by

$$\begin{matrix}{V}_{th} = ( {V}_{d} \cdot 1 + {V}_{ref} \cdot 2 ) / 3 \\ = 2 ( {V}_{os1} + {V}_{os2} ) / 3\end{matrix}$$

Thus, in the comparator 5, since V_{d}<Vₜₕ, the binary signal S is low (=“0”).

In FIG. 1, when a light signal is incident to the photodiode 1, a current I_{pd} flows therethrough. As a result, in the amplifier 2, the current I_{pd} flows through the negative feedback resistor 22, so that the detection voltage V_{d} is given by

V_{d}=V_{c}+I_{pd}·R_{f}

where R_{f} is a resistance of the negative feedback resistor 22. In this case, since V_{c}<Vₒₛ₁,

V_{d}<Vₒₛ₁+I_{pd}·R_{f}

Also, in the reference voltage generating circuit 3, the offset voltage Vₒₛ₂ is applied to the voltage V_{c}, so that the reference voltage V_{ref} is given by

V_{ref}<Vₒₛ₁+Vₒₛ₂

As a result, in the time constant circuit 3,

Vₜₕ=(V_{d}·1+V_{ref}·2)/3<Vₒₛ₁+I_{pd}·R_{f}+2·Vₒₛ₂/3

Thus, in the comparator 5, since V_{d}>Vₜₕ, the binary signal S is high (=“1”).

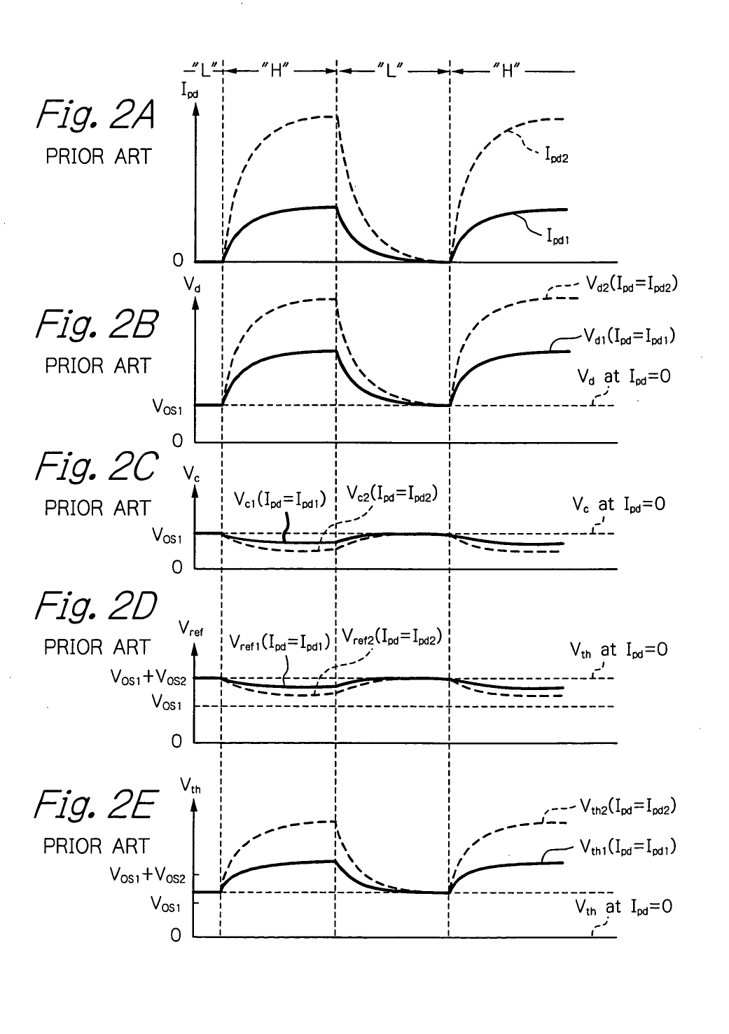

The operation of the photocurrent-to-binary signal conversion apparatus of FIG. 1 will be explained next with reference to FIGS. 2A, 2B, 2C, 2D, 3A, 3B, 4A and 4B where two different photocurrents I_{pd1} and I_{pd2} (>I_{pd1}) flow through the photodiode 1 as shown in FIG. 2A.

As shown in FIG. 2B, detection voltages V_{d1} and V_{d2} in response to the photocurrents I_{pd1} and I_{pd2}, respectively, are outputted from the amplifier 2.

As shown in FIG. 2C, the voltage V_{c} at the cathode of the photodiode 1 is decreased. In this case, a voltage V_{c2} at I_{pd}=I_{pdz} is lower than a voltage V_{c1} at I_{pd}=I_{pd}=I_{pd1}. Therefore, as shown in FIG. 2D, since the offset voltage Vₒₛ₂ is applied to the reference voltage V_{ref}, a reference voltage V_{ref2} at I_{pd}=I_{pd2} is lower than a reference voltage V_{ref1} at I_{pd}=I_{pd1}.

Therefore, as shown in FIG. 2E, a threshold voltage Vₜₕ₁ at I_{pd}=I_{pd1} and a threshold voltage Vₜₕ₂ at I_{pd}=I_{pd2} are obtained from the detection voltage V_{d1} and V_{d2} as shown in FIG. 2B and the reference voltages V_{ref1} and V_{ref2} as shown in FIG. 2D.

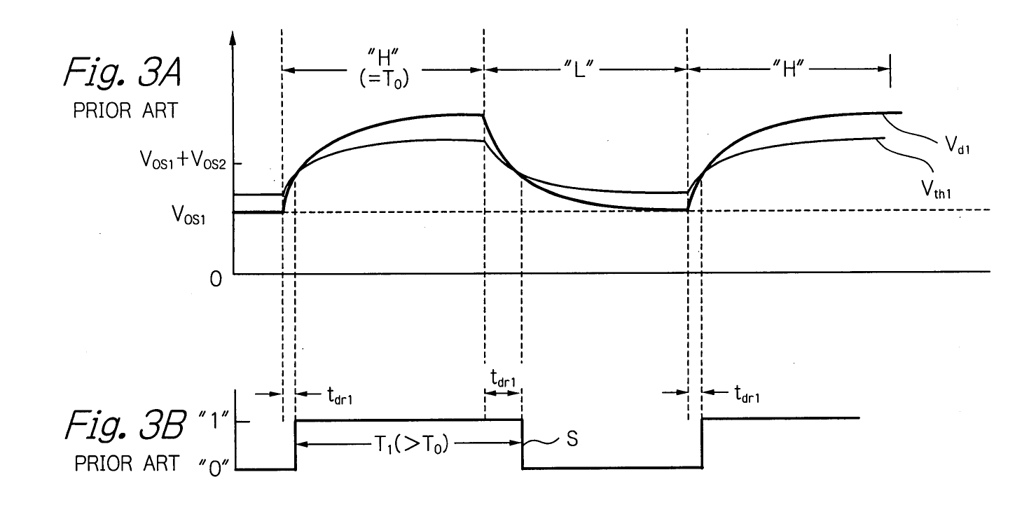

When the photocurrent I_{pd1} flows through the photodiode 1, the detection voltage V_{d1} crosses the threshold voltage Vₜₕ₁ at an acute angle as shown in FIG. 3A. Therefore, as shown in FIG. 3B, a falling time t_{df1} is longer than a rising time t_{dr1} due to the time constant circuit 4. As a result, a time period T₁ of high level (=“1”) of the binary signal S is longer than a time period T₀ of a high level of the photocurrent I_{pd}.

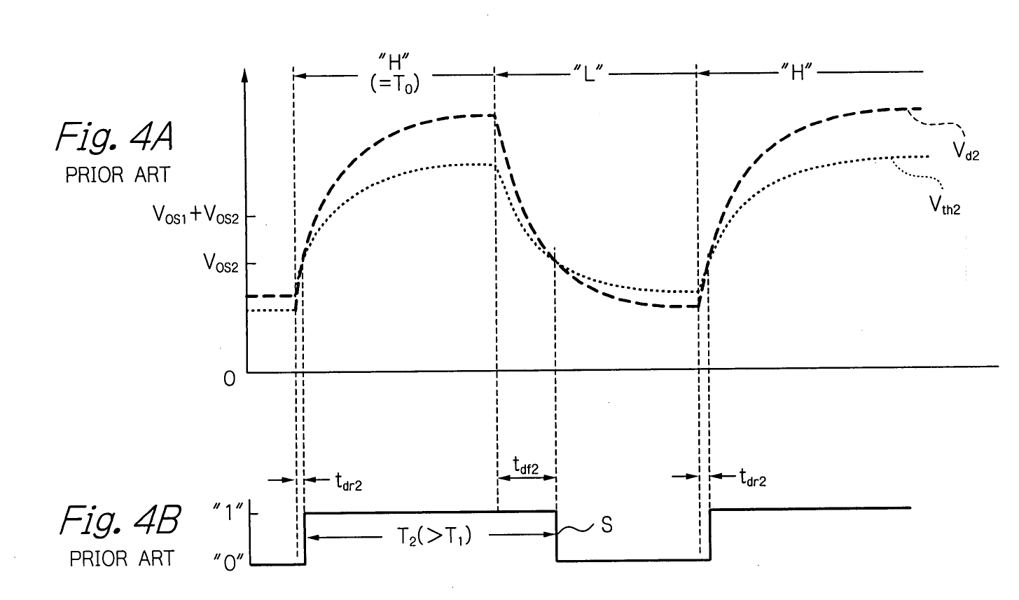

Also, when the photocurrent I_{pd2} flows through the photodiode 1, the detection voltage V_{d2} crosses the threshold voltage Vₜₕ₁ at an acute angle as shown in FIG. 4A. Therefore, as shown in FIG. 4B, a falling time t_{df2} is longer than a rising time t_{dr2} due to the time constant circuit 4. As a result, a time period T₂ of high level (=“1”) of the binary signal S is longer than a time period T₁ of a high level of the binary signal S as shown in FIG. 3B.

Thus, T₀<T₁<T₂. Therefore, waveform distortion between a photocurrent and a binary signal and waveform distortion between different binary signals corresponding to different levels of photocurrents are generated.

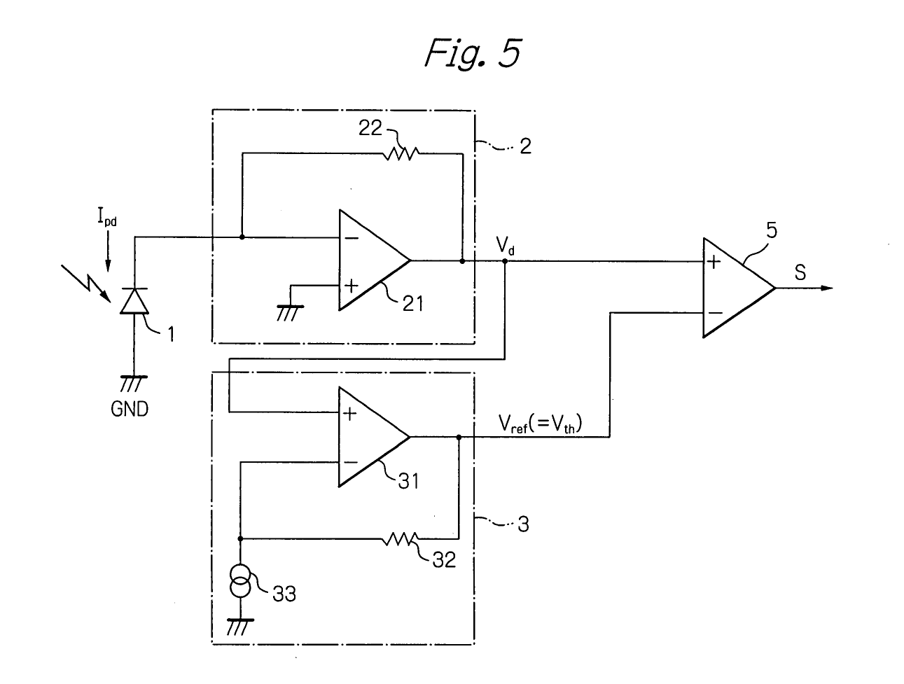

A first embodiment of the photocurrent-to-binary signal conversion apparatus according to the present invention will be explained next with reference to FIGS. 5, 6A, 6B, 6C, 7A, 7B, 8A and 8B.

In FIG. 5, which illustrates a first embodiment of the photocurrent-to-binary signal conversion apparatus according to the present invention, the reference voltage generating circuit 3 of FIG. 1 is connected to the output of the amplifier 2, not the input of the amplifier 2. Also, the time-constant circuit 4 of FIG. 1 is deleted, so that the reference voltage V_{ref} as the threshold voltage Vₜₕ is supplied directly to the comparator 5.

In FIG. 5, when no light signal is incident to the photodiode 1, no photocurrent I_{pd} flows therethrough. As a result, in the amplifier 2, since no current flows through the negative feedback resistor 22, the detection voltage V_{d} is the same as the voltage at the cathode of the photodiode 1. In this case,

V_{d}=Vₒₛ₁

where Vₒₛ₁ is an offset voltage of the operational amplifier 21 depending the current of a constant current source (see: 211a of FIG. 10A) therein. Also, in the reference voltage generating circuit 3, since the negative feedback resistor 32 and the constant current source 33 generate an offset voltage Vₒₛ₂, the offset voltage Vₒₛ₂ is applied to the detection voltage V_{d}, so that the reference voltage V_{ref} (=Vₜₕ) is given by

V_{ref}(=Vₜₕ)=Vₒₛ₁+Vₒₛ₂

Thus, in the comparator 5, since V_{d}<Vₜₕ, the binary signal S is low (=“0”).

In FIG. 5, when a light signal is incident to the photodiode 1, a current I_{pd} flows therethrough. As a result, in the amplifier 2, the current I_{pd} flows through the negative feedback resistor 22, so that the detection voltage V_{d} is given by

V_{d}=V_{c}+I_{pd}·R_{f}

where V_{c} is a voltage at the cathode of the photodiode 1; and R_{f} is a resistance of the negative feedback resistor 22. In this case, since V_{c}<Vₒₛ₁,

V_{d}<Vₒₛ₁+I_{pd}·R_{f}

Also, in the reference voltage generating circuit 3, the offset voltage Vₒₛ₂ is applied to the detection voltage V_{d}, so that the reference voltage V_{ref} is given by

V_{ref}(=Vₜₕ)=V_{d}+Vₒₛ₂

Thus, in the comparator 5, since V_{d}>Vₜₕ, the binary signal S is high (=“1”).

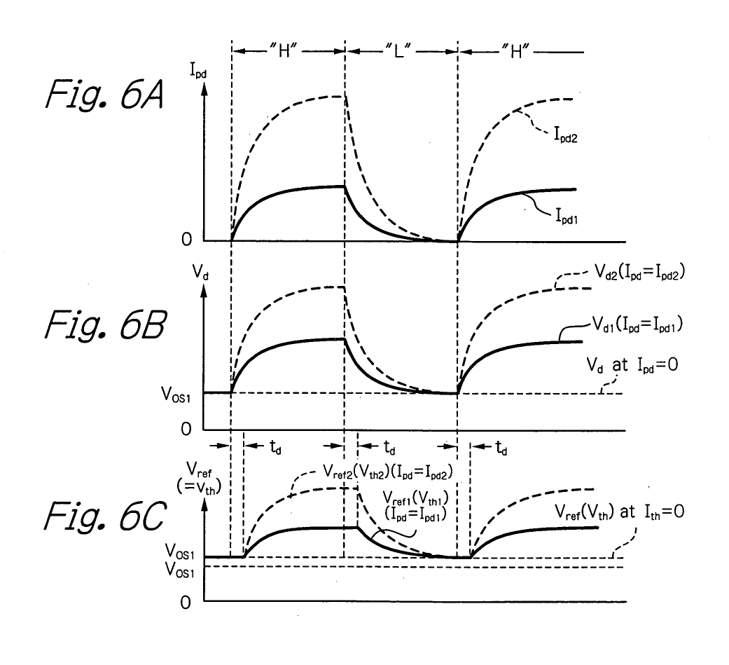

The operation of the photocurrent-to-binary signal conversion apparatus of FIG. 5 will be explained next with reference to FIGS. 6A, 6B, 6C, 7A, 7B, 8A and 8B where two different photocurrents I_{pd1} and I_{pd2} (>I_{pd1}) flow through the photodiode 1 as shown in FIG. 6A.

As shown in FIG. 6B, detection voltage V_{d1} and V_{d2} in response to the photocurrents I_{pd1} and I_{pd2}, respectively, are outputted from the amplifier 2.

As shown in FIG. 6C, since the offset voltage Vₒₛ₂ is applied to the detection voltage V_{d}, a reference voltage V_{ref2} (=Vₜₕ₂) at I_{pd}=I_{pd2} is lower than a reference voltage V_{ref1} (=Vₜₕ₂) at I_{pd}=I_{pd1}.

Note that, as shown in FIGS. 6B and 6C, since the detection voltage V_{d} of the amplifier 2 is supplied to the reference voltage generating circuit 3, the reference voltage V_{ref} (=Vₜₕ) has a delay time t_{d} determined by a time constant of the reference voltage generating circuit 3 as compared with the detection voltage V_{d}.

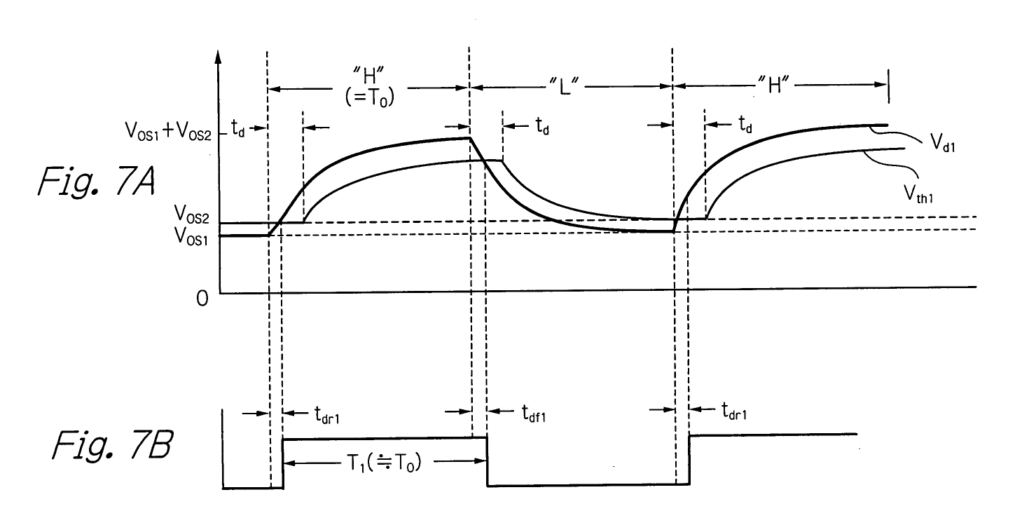

When the photocurrent I_{pd1} flows through the photodiode 1, the detection voltage V_{d1} crosses the threshold voltage Vₜₕ₁ at an angle of about 90° as shown in FIG. 7A. Therefore, as shown in FIG. 7B, a falling time t_{df1} is about the same as a rising time t_{dr1}. As a result, a time period T₁ of a high level (=“1”) of the binary signal S is about the same as a time period T₀ of a high level of the photocurrent I_{pd1}.

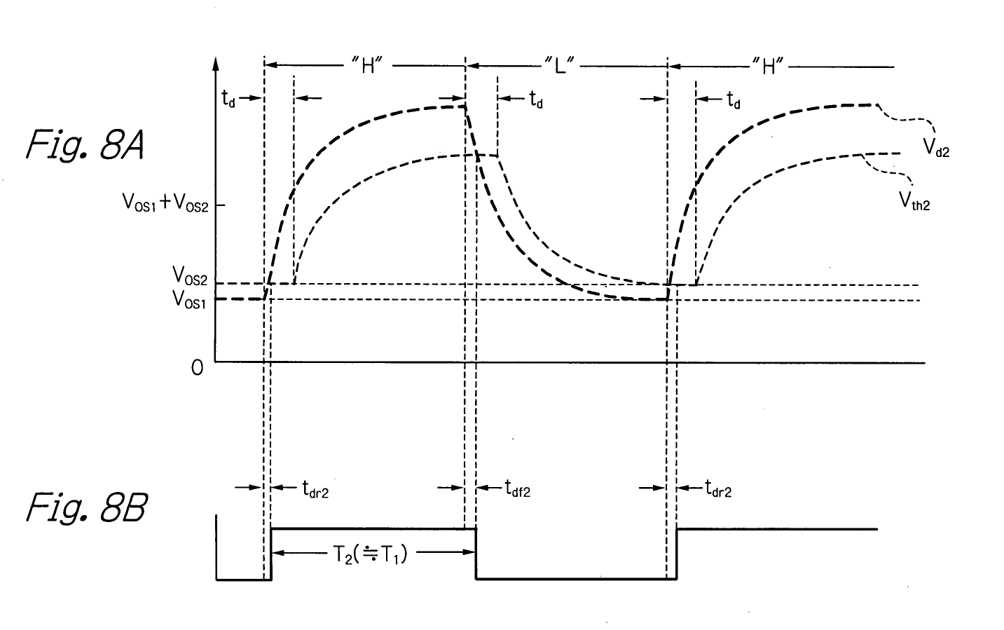

Also, when the photocurrent I_{pd2} flows through the photodiode 1, the detection voltage V_{d2} crosses the threshold voltage Vₜₕ₂ at an angle of about 90° as shown in FIG. 8A. Therefore, as shown in FIG. 8B, a falling time t_{df2} is about the same as a rising time t_{dr2}. As a result, a time period T₂ of a high level (=“1”) of the binary signal S is about the same as a time period T₁ of a high level of the binary signal S as shown in FIG. 8B.

Thus, T₀≈T₁≈T₂. Therefore, waveform distortion between a photocurrent and a binary signal and waveform distortion between different binary signals corresponding to different levels of photocurrents are hardly generated.

Also, as shown in FIGS. 7A and 8A, since the detection voltage V_{d} crosses the threshold voltage Vₜₕ at a large angle such as about 90°, the noise output of the comparator 5 caused by the jitter components of the detection voltage V_{d} and the threshold voltage Vₜₕ can be suppressed.

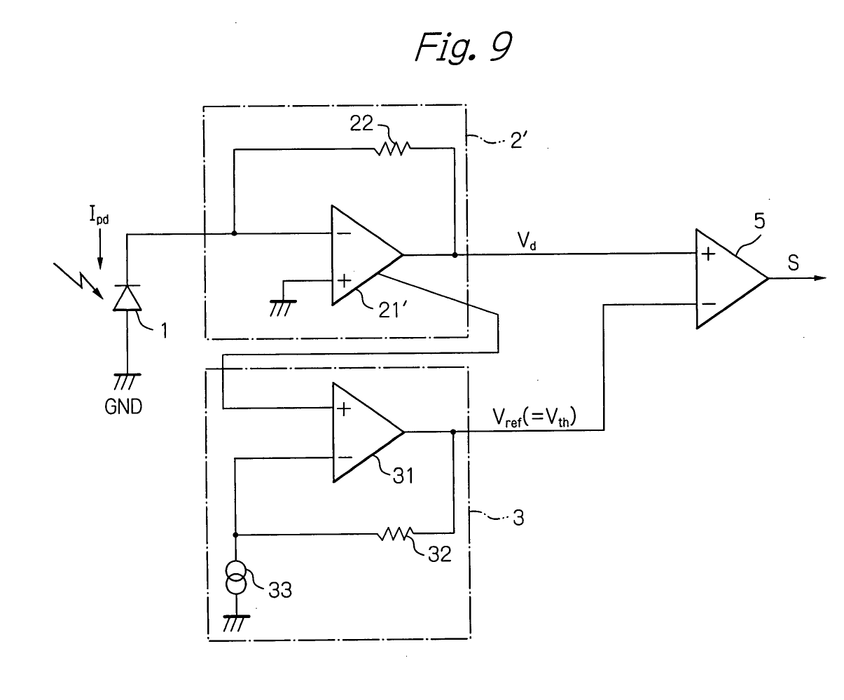

In FIG. 9, which illustrates a second embodiment of the photocurrent-to-binary signal conversion apparatus according to the present invention, the amplifier 2 of FIG. 5 is replaced by an amplifier 2′ where the operational amplifier 21 of FIG. 5 is replaced by an operational amplifier 21′. That is, the input of the reference voltage generating circuit 3 of FIG. 5, i.e., the non-inverting input of the amplifier 31 of FIG. 5 is connected to an intermediate stage of the operational amplifier 21′ of the amplifier 2′ having the same phase as that of the detection voltage V_{d}.

In more detail, as illustrated in FIG. 10A, which is a detailed circuit diagram of a first example of the amplifier 2′ of FIG. 9, the operational amplifier 21′ is constructed by a differential amplifier 211 having a constant current source 211a and an output amplifier 212 including a push-pull output circuit. The detection voltage V_{d} is derived from the output amplifier 212, while the reference voltage generating circuit 3 is connected to the differential amplifier 211.

On the other hand, as illustrated in FIG. 10B, which is a detailed circuit diagram of a second example of the amplifier 2′ of FIG. 9, the operational amplifier 21′ is constructed by a first inverter stage formed by a constant current source 213 and an N-channel MOS transistor 214, a second inverter stage formed by a constant current source 215 and an N-channel MOS transistor 216, and a final inverter stage formed by a constant current source 217 and an N-channel MOS transistor 218. The detection voltage V_{d} is derived from the final inverter stage, while the reference voltage generating circuit 3 is connected to the first inverter stage.

Thus, the input voltage of the reference voltage generating circuit 3 has the same phase as that of the detection voltage V_{d}, however, a delay time t_{d}′ of the reference voltage V_{ref}(=Vₜₕ) as compared with the detection signal V_{d} is smaller than the delay time t_{d} in the first embodiment.

The operation of the photocurrent-to-binary signal conversion apparatus of FIG. 9 is substantially the same as that of the photocurrent-to-binary signal conversion apparatus of FIG. 5, except for the above-mentioned delay time, so that the stability of the operation deteriorates a little due to the above-mentioned smaller delay time t_{d}′.

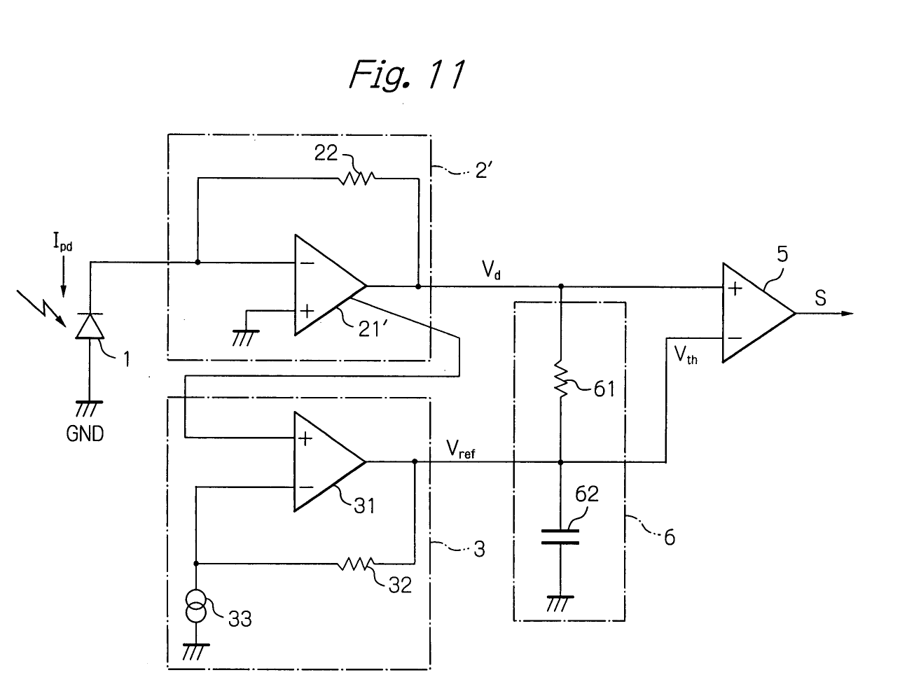

In FIG. 11, which illustrates a third embodiment of the photocurrent-to-binary signal conversion apparatus according to the present invention, a delay circuit 6 formed by a resistor 61 and a capacitor 62 is added to the elements of FIG. 9. That is, the delay circuit 6 is connected between the reference voltage generating circuit 3 and the comparator 5 of FIG. 9. As a result, the reference voltage V_{ref} is delayed by the delay circuit 6 as compared with the detection voltage V_{d}, to thereby generate the threshold voltage Vₜₕ. Therefore, a delay time t_{d}″ of the threshold voltage Vₜₕ as compared with the detection voltage V_{d} is comparable to the delay time t_{d} in the first embodiment. As a result, the stability of the operation is improved and is comparable to that of the first embodiment.

As explained hereinabove, according to the present invention, the waveform distortion between a photocurrent and a binary signal and the waveform distortion between different binary signals corresponding to different levels of photocurrents can be suppressed.

1. A photocurrent-to-binary signal conversion apparatus comprising:
a light receiving element for receiving a light signal so that a photocurrent in response to said light signal flows through said light receiving element;
an amplifier, connected to said light receiving element, for converting said photocurrent into a detection voltage;
a reference voltage generating circuit, connected to said amplifier, for offsetting said detection voltage on the side of said detection voltage to generate a reference voltage; and
a comparator, connected to said amplifier and said reference voltage generating circuit, for comparing said detection voltage with said reference voltage to generate a binary signal in accordance with whether or not said detection voltage is higher than said reference voltage.

2. The photocurrent-to-binary signal conversion apparatus as set forth in claim 1, wherein said light receiving element comprises a photodiode having a grounded anode.

3. The photocurrent-to-binary signal conversion apparatus as set forth in claim 1, wherein said amplifier comprises a non-inverting amplifier, and said reference voltage generating circuit comprises an inverting amplifier.

4. The photocurrent-to-binary signal conversion apparatus as set forth in claim 1, wherein said amplifier comprises:
an operational amplifier having an inverting input connected to said light receiving element, a grounded non-inverting input, and an output for outputting said detection voltage; and
a negative feedback resistor connected between the output and non-inverting input of said operational amplifier.

5. The photocurrent-to-binary signal conversion apparatus as set forth in claim 1, wherein said reference voltage generating circuit comprises:
an operational amplifier having a non-inverting input connected to said amplifier, an inverting input and an output for generating said reference voltage;
a negative feedback resistor connected between the output and inverting input of said operational amplifier; and
a constant current source connected to the inverting input of said operational amplifier and said negative feedback resistor.

6. A photocurrent-to-binary signal conversion apparatus comprising:
a light receiving element for receiving a light signal so that a photocurrent in response to said light signal flows through said light receiving element;
an amplifier, connected to said light receiving element, for converting said photocurrent into a detection voltage;
a reference voltage generating circuit, connected to an intermediate stage of said amplifier, for offsetting a voltage at said intermediate stage on the side of said voltage at said intermediate stage to generate a reference voltage, said voltage at said intermediate stage having the same phase as said detection voltage; and
a comparator, connected to said amplifier and said reference voltage generating circuit, for comparing said detection voltage with said reference voltage to generate a binary signal in accordance with whether or not said detection voltage is higher than said reference voltage.

7. The photocurrent-to-binary signal conversion apparatus as set forth in claim 6, wherein said light receiving element comprises a photodiode having a grounded anode.

8. The photocurrent-to-binary signal conversion apparatus as set forth in claim 6, wherein said amplifier comprises a non-inverting amplifier, and said reference voltage generating circuit comprises an inverting amplifier.

9. The photocurrent-to-binary signal conversion apparatus as set forth in claim 6, wherein said amplifier comprises:
a first operational amplifier having an inverting input connected to said light receiving element, a grounded non-inverting input, and an output for outputting said detection voltage; and
a negative feedback resistor connected between the output and non-inverting input of said first operational amplifier,
said first operational amplifier comprising a differential amplifier for amplifying a difference between voltages at said inverting input and said non-inverting input and an output amplifier connected to said differential amplifier for amplifying an output signal thereof to generate said detection voltage, said differential amplifier forming said intermediate stage.

10. The photocurrent-to-binary signal conversion apparatus as set forth in claim 6, wherein said amplifier comprises:
a first operational amplifier having an inverting input connected to said light receiving element, a grounded non-inverting input, and an output for outputting said detection voltage; and
a negative feedback resistor connected between the output and non-inverting input of said first operational amplifier,
said first operational amplifier comprising a plurality of inverter stages connected in series, one stage of said inverter stages except for a final stage of said inverter stages forming said intermediate stage.

11. The photocurrent-to-binary signal conversion apparatus as set forth in claim 6, wherein said reference voltage generating circuit comprises:
a second operational amplifier having a non-inverting input connected to said intermediate stage of said amplifier, an inverting input and an output for generating said reference voltage;
a negative feedback resistor connected between the output and inverting input of said second operational amplifier; and
a constant current source connected to the inverting input of said second operational amplifier and said negative feedback resistor.

12. The photocurrent-to-binary signal conversion apparatus as set forth in claim 6, further comprising a delay circuit, connected between said reference voltage generating circuit and said comparator, for delaying said reference voltage.

13. The photocurrent-to-binary signal conversion apparatus as set forth in claim 12, wherein said delay circuit comprises:
a resistor connected between an output of said amplifier and an output of said reference voltage generating circuit; and
a capacitor connected to the output of said reference voltage generating circuit.
